(19) United States
(12) Patent Application Publication
(10) Pub. No.: US 2023/0205669 A1
(43) Pub. Date: Jun. 29, 2023

(54) METHOD FOR BUG LOCALISATION

(71) Applicant: INDIAN INSTITUTE OF TECHNOLOGY, BOMBAY, Mumbai (IN)

(72) Inventors: Virendra SINGH, Mumbai (IN); Binod KUMAR, Mumbai (IN); Vineesh V S, Mumbai (IN)

(21) Appl. No.: 18/086,796

(22) Filed: Dec. 22, 2022

(30) Foreign Application Priority Data
Dec. 23, 2021 (IN) 202121060151

(51) Int. Cl. G06F 11/36

(52) U.S. Cl. CPC G06F 11/3608

(57) ABSTRACT

The present invention relates to a method for bug localisation in an RTL description, the RTL description corresponding to a design. The method comprises the steps of identifying a failing property; obtaining a counterexample corresponding to the failing property; obtaining a plurality of supportive counterexamples, by iteratively modifying the failing property with signal-value combinations selected from the counterexample; mining assertions based on the plurality of supportive counterexamples; filtering and ranking the mined assertions for removing redundant assertions, and obtaining a filtered set of assertions; identifying and mapping a set of one or more RTL lines corresponding to each filtered assertion of the filtered set of assertions; identifying and mapping individual RTL lines corresponding to each of the filtered assertion of the filtered set of assertions; and prioritising each of the mapped RTL line, thereby localising a buggy RTL line.

### CROSS-REFERENCE TO RELATED PATENT APPLICATION

This application claims priority to and the benefit of Indian Patent Application No. 202121060151, filed Dec. 23, 2021, which is incorporated herein in its entirety by reference

### FIELD OF THE INVENTION

The present invention relates to a method for Bug Localization in an RTL Description.

### BACKGROUND OF THE INVENTION

With the emergence of innumerable connected devices in Internet-of-Things (IoT) computing paradigm and other related technologies, demand for small, complex, and feature-rich hardware designs keeps on continually increasing. Miniaturization of designs coupled with the incorporation of advanced features to enrich user experience invariably leads to a significant increase in the design complexity. Additionally, because of highly competitive market space, the design and verification engineers face an uphill task in adhering to the product release deadlines. During the stage of pre-silicon verification, there are chances of repetitive runs of different kinds of experiments for identifying design bugs and obtaining corrections for them. It is widely accepted that bug localization becomes one of the most difficult steps in achieving the time to-market deadlines during integrated circuits development.

Typically, waveform-based debugging is heavily utilized by verification engineers in the industry to understand simulation traces and come up with certain suspect candidates. This practice leads to elongated debug time and high dependence on the manual expertise available. Automatic bug localization from simulation traces of all kinds of designs is generally very tedious and requires multiple iterations of cause-and-effect analyses.

Straightforward application of automation has been successful to very limited designs that allow consistency-based compliance checks and analysis. Therefore, techniques for effective design bug localization can offer significant benefits in the form of obtaining quick design fixes. In spite of the wide usage of simulation-based verification strategies, the completeness of the correctness cannot be guaranteed. This can be significantly solved by formal verification methodologies such as model checking. However, fine-grained automatic bug identification from the model checking process turns out to be again a complicated task. As a result of the growing design complexity, analysing generated counter examples requires manual intervention.

State-of-the-art (SOTA) model checkers provide a waveform-based view of the counterexamples (CEX) for aid in analysis such as dependence of different signals present in CEX and their signal values at specific instants of time. However, such procedures lead to increased time as large number of suspect candidates appear.

Thus, there is a need in the art for a method for bug-localisation which addresses at least the aforementioned problems.

### SUMMARY OF THE INVENTION

In one aspect, the present invention is directed towards a method for bug localisation in an RTL description wherein the RTL description corresponds to a design. In the method, a failing property is identified and a counterexample is obtained corresponding to the failing property. A plurality of supportive counterexamples are obtained, by iteratively modifying the failing property with signal-value combinations selected from the counterexample. Assertions are mined based on the plurality of supportive counterexamples. The mined assertions are filtered and ranked for removing redundant assertions, and obtaining a filtered set of assertions. A set of one or more RTL lines is identified and mapped corresponding to each filtered assertion of the filtered set of assertions. Individual RTL lines corresponding are identified and mapped to each of the filtered assertion of the filtered set of assertions. Each of the mapped RTL line is prioritised, thereby localising a buggy RTL line.

In an embodiment of the invention, the method has the steps of identifying an output of all modules to which signals in the failing property belong; identifying target control signals from the output of all modules to which signals in the failing property belong; modifying the failing property by using the negated signal-value combinations of control signals present in a Cone of Influence of the target control signals; and obtaining a plurality of supportive counterexamples corresponding to the failing property and a modified failing property.

In a further embodiment of the invention, the method has the steps of generating a list of control signals in the Cone of Influence of the target control signals; and mining assertions from the list of control signals in the Cone of Influence of the target control signals.

In a further embodiment of the invention, the method has the steps of identifying a set of common assertions from the mined assertions, wherein common assertions corresponds to likelihood of presence of a bug; identifying a set of unique assertions from the mined assertions; and filtering and ranking the mined assertions based on the Cone of Influence.

In a further embodiment of the invention, the method has the steps of obtaining a control flow graph for the design by static analysis; identifying conditional statements within the control flow graph; extracting RTL line numbers of ‘if, case’ conditional statement; extracting RTL line numbers of ‘always’ conditional statement; determining whether RTL line numbers of ‘if, case’ conditional statement and ‘always’ conditional statement contain an antecedent corresponding to each of the filtered and ranked assertions; obtaining an individual RTL line mapping for each of the filtered and ranked assertions; and obtaining a set of final suspect RTL lines, prioritising each of the mapped RTL line, thereby localising a buggy RTL line.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a method for bug localisation in an RTL description, in accordance with an embodiment of the invention.

FIG. 2 illustrates further method steps involved in the method for bug localisation, in accordance with an embodiment of the invention.

FIG. 3 illustrates further method steps involved in the method for bug localisation, in accordance with an embodiment of the invention.

### DETAILED DESCRIPTION OF THE INVENTION

The present invention relates to a method for bug-localisation in a Register Transfer Language (RTL) description. Herein, the RTL description corresponds to a design.

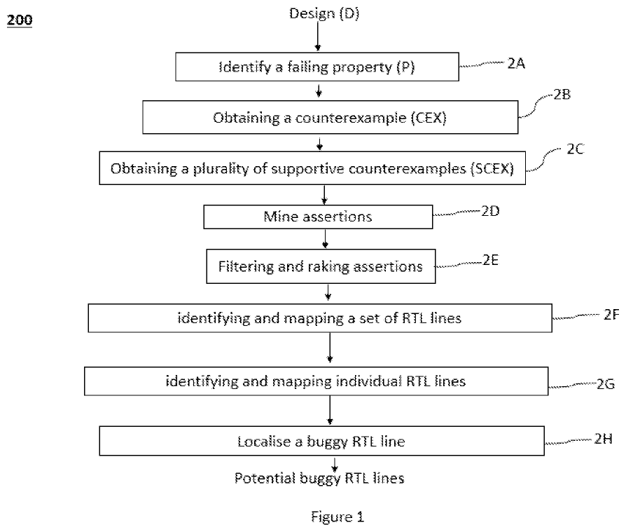

FIG. 1 illustrates the method steps involved in a method 200 for bug-localization in the RTL description, wherein the RTL description corresponds to the design (D). As illustrated in FIG. 1, at step 2A, a failed property (P) is identified in the RTL description. At step 2B, a counterexample (CEX) is obtained corresponding to the failing property (P). In an embodiment, the counterexample (CEX) is obtained. However, there can be multiple execution scenarios leading to the root cause of the bug. Therefore, at step 2C, a plurality of supportive counterexamples (SCEX) are obtained, by iteratively modifying the failing property (P) with signal-value combinations selected from the counterexample (CEX). The supportive counterexamples (SCEX) are capable of exposing the multiple execution scenarios leading to the root cause of the bug. The rationale behind generating supportive counterexample (SCEX) lies in the fact that an analysis of multiple paths of the design (D) increases the probability of pinpointing exactly to the bug. This leads to a reduced number of suspects for the respective fix (or, correction) by the designers.

At step 2D, a plurality of assertions are mined based on the plurality of supportive counterexamples (SCEX). Assertions can be expressed as a representation of the design specifications. Akin to the definition of properties, they are written in terms of the design signals and convey their functionality. While the main property (P) can be longer in length whereas the assertions are relatively shorter. It is the difference in the clock cycles of antecedent and consequent getting assigned their respective values. A few parameters are passed to the miner such as temporal depth and maximum number of antecedents. These factors assist in generating different quality of assertions from the miner corresponding to different bug scenarios.

At step 2E, the mined assertions are filtered and ranked for removing redundant assertions and a filtered and ranked set of assertions is obtained. Manual writing of assertions can be error-prone and turn out to be an arduous task. Additionally, the manually written assertions cannot be exhaustive in nature and may not reflect the temporal depth. Therefore, automatic assertion mining can provide quality assertions within a short time. The proposed invention utilizes static features of the design and decision tree-based mining from counterexample traces via classification and regression trees (CART) specifically.

Classification and regression tree (CART) is one of the decision tree-based techniques to mine assertions from given input traces. In an embodiment, the method 200 utilizes CART for generating assertions from the counterexample traces of the design (D). A classification tree splits the dataset based on certain parameters. In a regression tree, a regression model is utilized to fit the target variable based on each of the independent variables. From CART, an assertion can be formed by traversing the path from root up to the leaves.

It is a usual practice in most debug scenarios to focus on some specific sets of signals compared to the signals of an entire module (M) of the design (D). Corresponding to these signals, the inward logical cone can be defined that affects them as “Cone-of-Influence (CoI)”. For a given property (P), a subset of the logic contained in the CoI of the property that is capable of establishing its correctness/falsification is referred.

At step 2F, a set of one or more RTL lines are identified and mapped corresponding to each filtered assertion of the filtered set of assertions obtained at step 2E. At step 2G, individual RTL lines are identified and mapped corresponding to each of the filtered assertion of the filtered set of assertions. Finally at step 2H, each of the mapped RTL line is prioritised and thereby a buggy RTL line is localised. In an embodiment, the method 200 utilizes static analysis for achieving this mapping. This analysis leads to binning wherein closest suspects are categorized and provided as inputs to the designers for further detailed inspection. One of the direct ways to pinpoint cause of bug can be through exactly mapping to the different procedural blocks present in the design description. In this work, the localization is targeted up to the level of always or case or if blocks in the group of RTL lines that have the highest probability of containing the bug.

In an embodiment, a binning-based methodology is utilised for obtaining the probable list of suspects. For example, following is the order in which the mapped RTL lines are prioritized for checking bugs i.e., assigning into different bins for the purpose of localization.

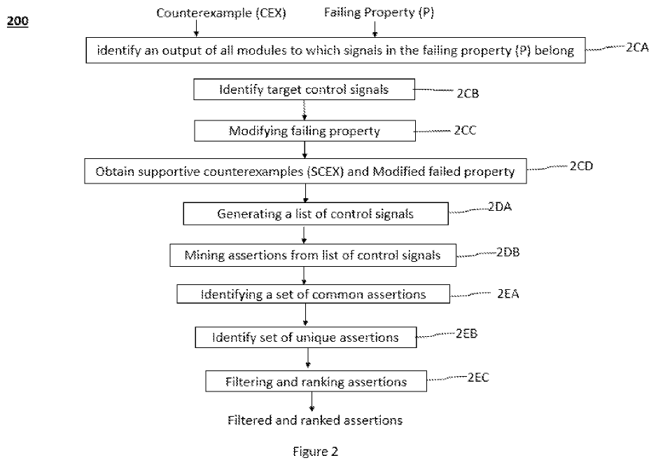

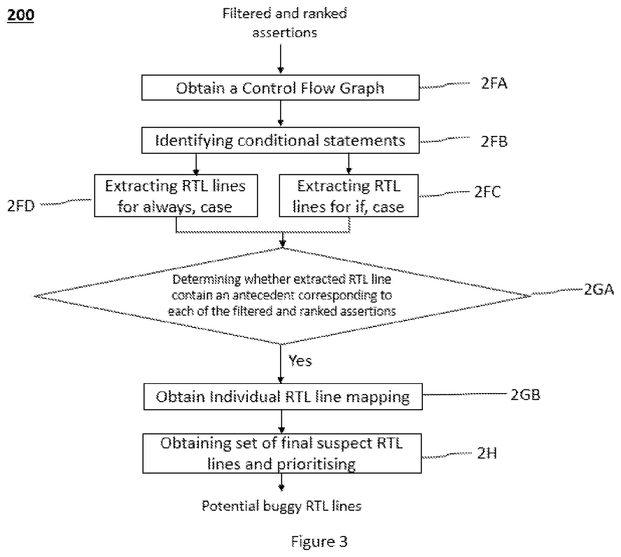

FIGS. 2 and 3 further illustrate the sub-steps involved in the method steps 2A-2H of the method 200, in accordance with an embodiment of the present invention. As illustrated, within step 2C, at step 2CA, an output of all modules to which signals in the failing property (P) belong is identified. Thereafter, at step 2CB, target control signals from the output of all modules to which signals in the failing property (P) belong are identified. At step 2CC, the failing property (P) is modified by using the negated signal-value combinations of control signals present in a Cone of Influence (CoI) of the target control signals. Thereafter, at step 2CD, obtaining a plurality of supportive counterexamples are obtained corresponding to the failing property (P) and a modified failing property.

Since there is invariably a large number of internal signals in complex designs, there is a need to identify a set of target signals that are required to be looked for in the original counterexample (CEX) for modifying the property (P). As explained above, the outputs of all the modules to which the signals in the original failing property (P) belong are identified first. To reduce the number of signals further, only the control signals among them are considered and put in target signals. The original property (P) is modified multiple times by using the negated the signal-value combination of the control signals present in the CoI of target signals. The purpose is to find different ways of exposing the bug. If the modified property is failing, a counterexample (CEX) is obtained that contains the buggy RTL line. Thereafter, multiple supportive counterexamples (SCEX) are obtained from the failing original property as well as the modified properties that failed.

When the property (P) is modified with the signal-value combinations selected from the counterexample trace, it is possible that the condition mentioned in the modified property is not feasible in the design (D). Those properties will lead to scenarios where antecedents (also, referred to as pre-condition) failure happens in the model checker. On the contrary, when a property (P) fails, there is a chance that it leads to a different path to the bug. Many such counterexample traces ensure that a large number of scenarios are covered where the bug is exposed. Mining assertions from such traces provides the relations between the different signals which are potentially pointing towards the bug.

As further illustrated in FIG. 2, within step 2D, at step 2DA, a list of control signals is generated in the Cone of Influence of the target control signals; and at step 2DB, assertions are mined from the list of control signals in the Cone of Influence of the target control signals. As explained, a list of control signals is generated in the Cone of Influence (CoI) of the target signals. The list of signals includes different names with delay number annotations upto a maximum temporal depth. Hence, the miner is provided the information if the value of a signal some clock cycles before the current cycle affects the value of the target signal or not. For example, if a signal is present in the CoI of a target signal, it means that the value of the signal three cycles before affects the value of the target signal in the current cycle.

The signal-value information database has entries of both types, i.e. with and without the temporal information present in it. The decision tree is constructed with all those signals, and assertions are generated with the temporal value of signals still present at the start of the signal. This temporal information present at the beginning of each signal is later converted to standard delays. The procedure used to convert begins with first finding the highest delay present in all the signals present in the antecedent of the assertion. Then the methodology divides the antecedent signals into different groups corresponding to the same delays. Finally, the methodology starts writing the signals group-wise, starting with the group with the highest delay and going in decreasing order of the delays.

As further illustrated in FIG. 2, within step 2E, at step 2EA, a set of common assertions are identified from the mined assertions, wherein common assertions corresponds to likelihood of presence of a bug. At step 2EB, a set of unique assertions are identified from the mined assertions and step 2EC, the mined assertions are filtered and ranked based on the Cone of Influence. It is possible that multiple assertions may lead to the same path while trying to expose the bug. Only one of these assertions need to be considered, and the others are marked as redundant/common assertion. Following rules are used to determine whether two assertions are common (here, conjunction is a set of signal-value pairs in the antecedent which have the same temporal delay):
consequent of both the assertions has the same signal-value combination.
temporal delay between successive conjunctions in the antecedent of both assertions are identical.
each of the conjunctions in both assertions should consist of the same set of propositions.

If the above three rules are followed, those two assertions are declared as common. Finally, we obtain a list of unique assertions which are to be utilized in the next step of the methodology. To further prune down the number of assertions, a filtering process is employed. During the filtering process, the methodology notes down the number of times an assertion was found common with the others. The assertion which is common more times is more likely to point towards the bug. The filtered assertions are ranked on the basis of CoI-based analysis to enable a prioritized mapping.

As illustrated in FIG. 3, within step 2F, at step 2FA, a control flow graph is obtained for the design by static analysis. At step 2FB, conditional statements are identified within the control flow graph. At step 2FC, RTL line numbers of ‘if, case’ conditional statement are extracted and at step 2FD, RTL line numbers of ‘always’ conditional statement are extracted. Further, within step 2G, at step 2GA, whether RTL line numbers of ‘if, case’ conditional statement and ‘always’ conditional statement contain an antecedent corresponding to each of the filtered and ranked assertions, determined. If so, at step 2GB, an individual RTL line mapping for each of the filtered and ranked assertions is obtained. Thereafter, at step 2H, a set of final suspect RTL lines is obtained and each of the mapped RTL line is prioritised, thereby localising a buggy RTL line.

Static analysis is utilised to get Control Flow Graph (CFG) for the design (D). The CFG also contains the lines where the control signals are present. By extracting these line numbers, all the blocks present in the design (D) can be identified since the control signals are present in the conditional statements (blocks). Thus, RTL line numbers are extracted of if, case and always blocks. These statements are categorised into different bins as mentioned to perform fine-grained localization as per the priority order of these bins.

For each assertion, there is availability of the antecedent signals and the information about the respective conditional statement line number, conditional statement type and signals present in those conditional statements (or the procedural blocks). Therefore, for every assertion, all the case/if/always blocks are determined which have at least one of the antecedent signals in them.

It is highly probable to obtain a high number of mapped RTL lines for each assertion. The union of modules to which all the antecedent and consequent signals belong to for each assertion is determined. For that assertion, out of all the mapped RTL lines, only those blocks which belong to the union of the modules determined for that assertion are considered. This gives individual RTL mapping for each assertion.

The union of all the mapped RTL lines obtained after module-wise mapping for all assertions is now taken. The process of taking union of RTL lines is done separately for case/if blocks and always blocks. It has been observed that among the mapped case/if blocks, those inside the mapped always blocks are more probable to be buggy. These ranked RTL lines can be analysed by the verification engineer so that he/she can prioritize these RTL regions for bug localization. It is worth to note that for a mapped case/if blocks, all the statements inside that case/if block should be checked for bugs and not only the particular line of that case/if /always block.

Advantageously, the present invention provides a method for bug localisation that does not require an extensive design simulation. Further, the present invention provides an intelligent selection and ranking of the assertions in an automatic manner.

The present invention thus provides for reduction of time involved in bug localisation and does not require tedious multiple iterations of cause effect analysis. Further, manual intervention is minimised.

While the present invention has been described with respect to certain embodiments, it will be apparent to those skilled in the art that various changes and modifications may be made without departing from the scope of the invention as defined in the following claims.

We claim:

1. A method (200) for bug-localisation in an RTL description, the RTL description corresponding to a design (D), comprising the steps of:
identifying a failing property (P);
obtaining a counterexample (CEX) corresponding to the failing property;
obtaining a plurality of supportive counterexamples (SCEX), by iteratively modifying the failing property (P) with signal-value combinations selected from the counterexample (CEX);
mining assertions based on the plurality of supportive counterexamples (SCEX);
filtering and ranking the mined assertions for removing redundant assertions, and obtaining a filtered set of assertions;
identifying and mapping a set of one or more RTL lines corresponding to each filtered assertion of the filtered set of assertions;
identifying and mapping individual RTL lines corresponding to each of the filtered assertion of the filtered set of assertions; and
prioritising each of the mapped RTL line, thereby localising a buggy RTL line.

2. The method (200) as claimed in claim 1, comprising the steps of:
identifying an output of all modules to which signals in the failing property (P) belong;
identifying target control signals from the output of all modules to which signals in the failing property (P) belong;
modifying the failing property (P) by using the negated signal-value combinations of control signals present in a Cone of Influence of the target control signals; and
obtaining a plurality of supportive counterexamples (SCEX) corresponding to the failing property (P) and a modified failing property.

3. The method (200) as claimed in claim 2, comprising the steps of;
generating a list of control signals in the Cone of Influence of the target control signals; and
mining assertions from the list of control signals in the Cone of Influence of the target control signals.

4. The method (200) as claimed in claim 3, comprising the steps of:
identifying a set of common assertions from the mined assertions, wherein common assertions correspond to likelihood of presence of a bug;
identifying a set of unique assertions from the mined assertions; and
filtering and ranking the mined assertions based on the Cone of Influence.

5. The method (200) as claimed in claim 4, comprising the steps of:
obtaining a control flow graph for the design (D);
identifying conditional statements within the control flow graph;
extracting RTL line numbers of ‘if, case’ conditional statement;
extracting RTL line numbers of ‘always’ conditional statement;
determining whether RTL line numbers of ‘if, case’ conditional statement and ‘always’ conditional statement contain an antecedent corresponding to each of the filtered and ranked assertions;
obtaining an individual RTL line mapping for each of the filtered and ranked assertions; and
obtaining a set of final suspect RTL lines, prioritising each of the mapped RTL line, thereby localising a buggy RTL line.
